(19) United States
(12) Patent Application Publication
(10) Pub. No.: US 2019/0177633 A1
(43) Pub. Date: Jun. 13, 2019

(54) METHOD FOR MANUFACTURING A LUBRICITY ADDITIVE FOR FUEL HAVING A LOW SULFUR CONTENT

(71) Applicant: TOTAL MARKETING SERVICES, Puteaux (FR)

(72) Inventors: Lidwine ABIAD DEVAUX, Lyon (FR); Olivier LANGLOIS, Montagny (FR); Alois JOASSARD, La Garenne Colombes (FR)

(73) Assignee: TOTAL MARKETING SERVICES, Puteaux (FR)

(21) Appl. No.: 16/326,025

(22) PCT Filed: Aug. 16, 2017
(86) PCT No.: PCT/FR2017/052236

§ 371 Date: Feb. 15, 2019

(30) Foreign Application Priority Data
Aug. 18, 2016 (FR) 1657807

(51) Int. Cl. C10L 10/08; C11C 1/02; C11C 3/02; C10L 1/19; C11C 1/08; C10M 101/04

(52) U.S. Cl. CPC C10L 10/08; C11C 1/025; C11C 3/02; C10L 1/191; C11C 1/08; C10N 2240/10; C10L 2200/0484; C10L 2270/023; C10L 2270/026; C10L 2290/547; C10M 2207/401; C10M 101/04

(57) ABSTRACT

A process for manufacturing a lubricant additive for internal combustion engine fuel, especially for diesel fuel, in which the additive is derived, especially directly, from the esterification of acid oils, such acid oils are especially coming from the acidification of neutralization paste obtained via a process for refining, preferably a process for chemical refining, and especially a process for saponifying, one or more oils chosen from a plant oil and/or an animal oil, and the lubricant additive is more particularly intended for fuels with a low sulfur content, for example less than 500 ppm (weight).

### TECHNICAL FIELD

The present invention relates to a process for manufacturing a lubricant additive for internal combustion engine fuel, especially for low-sulfur fuel. This additive is coming, especially directly, from the esterification of acid oils. Such acid oils are especially coming from the acidification of a neutralization paste obtained via a process for refining, preferably a process for chemical refining, especially a process for saponifying, one or more oils chosen from a plant oil and/or an animal oil.

The invention also relates to the use of esterified acid oils as described above as lubricant additive, especially for low-sulfur fuel.

In order to limit the discharges of pollutant emissions, many regulations impose relatively low contents of sulfur compounds in fuels, especially fuels of diesel type. To this end, the hydrocarbons used for manufacturing fuels are subjected to hydrotreatment and hydrocracking processes which remove all the compounds containing heteroatoms, and in particular the sulfur compounds they naturally contain. This removal of compounds containing heteroatoms leads to a loss of the lubricant power of the fuels thus obtained.

Now, fuels as a whole, and most particularly fuels of diesel type and fuels intended for aviation, must have lubrication capacities to protect the pumps, the injection systems and all the parts in motion with which these products come into contact in an internal combustion engine. Additives must then be added to these fuels in order to restore their lubricant power.

The lubricant additive obtained via the process according to the invention is more particularly intended for internal combustion engine fuels with a low sulfur content, for example less than 500 ppm (weight).

### PRIOR ART

The use of fatty acids as lubricant additives is known. In general, the fatty acids used are produced by fractionation of plant or animal oils. For example, tall oil fatty acids (TOFA) are known to have good lubricant properties in low-sulfur diesels (WO 98/04656). These fatty acids have a high acid number. The gain in improving the lubricity is high at low dosage.

The use of monoglycerides and diglycerides as lubricant additives is also known. Mono- and diglycerides are esters produced by reaction between fatty acids and glycerol. They have a very low acid number: this is referred to as neutral lubricity. However, the improvement in lubricity is not always immediate at low dosage, which may necessitate the use of larger amounts of additives, consequently increasing the cost of the treatment.

Finally, it is also known to use as additives specific mixtures of esters with a major content of monoesters (WO 97/04044). These specific mixtures of esters are especially (but not exclusively) prepared from mixtures containing linoleic or oleic acids. The preparation of these additives requires either the use of a specific mixture of acids before esterification, or the mixing of suitable esters.

There is thus a need for novel lubricant additives for fuel, especially internal combustion engine fuel, which are easy to obtain, inexpensive and efficient, especially for low-sulfur fuels, for example of diesel type.

### BRIEF SUMMARY OF THE INVENTION

Neutralization pastes are by-products of the refining, especially of the chemical refining, of raw oils (plant or animal). They are generally obtained, especially directly, by saponification of these oils. They thus contain the saponifiable species present in the fatty substances after their extraction. Their acidification makes it possible to obtain a mixture of fatty acids, esters and triglycerides known as “acid oil”. Acid oils are thus mixtures of active materials with a low cost price.

The Applicant proposes to use esterified acid oils as lubricant additive for internal combustion engine fuel.

A first subject of the invention thus relates to a process for manufacturing a lubricant additive for internal combustion engine fuel, comprising:

a) a step of providing an acid oil containing fatty acids, said acid oil being coming from the acidification of a neutralization paste obtained via a process for refining, preferably a process for chemical refining, especially a process for saponifying, one or more oils chosen from a plant oil and an animal oil,
b) a step of esterifying the acid oil obtained in step a), performed under conditions that are effective for converting into esters at least part, preferably all, of the fatty acids present in the acid oil.

The lubricant additive obtained via the manufacturing process according to the invention is thus coming solely from biomass. The lubricant additive according to the invention allows an appreciable increase in the lubricant nature of a fuel, even in small amounts. The invention thus also relates to a lubricant additive obtained via the process according to the invention.

The esterification step b) may be performed in the presence of polyhydric, cyclic or acyclic alcohol.

“Polyhydric alcohol” means an alcohol containing several hydroxyl (—OH) groups. Advantageously, the polyhydric alcohol used comprises at least three hydroxyl groups.

Advantageously, the esterification step b) may be performed in the presence of acyclic polyhydric alcohol, preferably glycerol.

According to the invention, it is thus possible to use an esterified acid oil, or a mixture of esterified acid oils, as lubricant additive for internal combustion engine fuel. This esterification may be performed as described above with reference to step b).

### DETAILED DESCRIPTION OF THE INVENTION

The lubricant additive according to the invention is obtained by esterification of acid oil coming from a process of acidification of at least one neutralization paste. This neutralization paste is obtained, especially directly, via a process for refining at least one oil chosen from a plant oil and an animal oil. This refining process is preferably a process for chemical refining, especially a process for saponifying one or more plant and animal oils.

The lubricant additive according to the invention is thus an esterified acid oil or a mixture of esterified acid oils. The lubricant additive is a neutral lubricant additive. “Neutral lubricant additive” means an additive with a low acid number, preferably less than or equal to 5 mg KOH/g, more preferentially less than or equal to 1 mg KOH/g.

The esterified acid oils are used as lubricant additive for internal combustion engine fuel, in particular low-sulfur fuels, in particular fuels with a sulfur content of less than 500 ppm (weight).

The fuel compositions, especially diesels, that may optionally contain biofuels (biodiesel), comprising such acid oils have improved lubricant properties.

It would not constitute a departure from the invention if the fuel were to be intended for hybrid engines combining internal combustion motorization and an alternative technology, for example electric.

Step a) of Providing an Acid Oil

During this step, an acid oil containing fatty acids is provided. “Acid oil” means either an oil coming from a single plant or animal oil, or a mixture of two or more of these oils.

The acid oil provided in step a) is coming from the refining of one or more oils chosen from a plant oil and an animal oil.

It is especially an oil coming from the acidification of a neutralization paste, this neutralization paste being coming from the refining, especially the chemical refining, of one or more oils chosen from a plant oil and an animal oil. More particularly, the neutralization paste is preferably coming, especially directly, from a process for saponifying one or more oils.

An acid oil may be defined as being fatty acid compositions neutralized with a base and then acidified.

The fatty acids advantageously originate from the saponification of a plant and/or animal oil, such as, without being limiting, a sunflower oil, soybean oil, rapeseed oil, palm oil, copra oil, groundnut oil, olive oil or fish oil, and conventionally comprise in the vast majority saturated or unsaturated C₁₆-C₁₈ carbon-based chains, among which are preferably unsaturated C₁₈ carbon-based chains. The plant oils usually comprise palmitic acid, oleic acid, linoleic acid and other acids in smaller amounts. The compositions of fatty acids neutralized with a base are typically neutralization pastes.

Typically, an acid oil contains from 20% to 70% by weight of fatty acids. The remainder is composed mainly of mono-, di- and triglycerides, generally essentially triglycerides. Note also the presence of some impurities in a content less than or equal to 0.5% by weight, preferably less than or equal to 0.1% by weight. These impurities are metal salts, for example sulphates, phosphates, etc.

Note that tall oil is not an acid oil because it comes from the saponification not of a vegetable or animal oil but from saponification of an alkaline solution of solid organic matter (wood chips, especially of conifers). Thus tall oil contains resins whereas an acid oil does not contain any.

According to a preferred embodiment, the acid oil provided in step a) is coming solely from one or more plant oils.

In general, the acid oil provided in step a) may comprise a water content of less than or equal to 3% by weight.

Advantageously, the acid oil provided in step a) may comprise a water content of less than or equal to 1% by weight, or even less than or equal to 0.8% by weight, in particular from 0.1% to 0.7% by weight.

Step a) of providing an acid oil may advantageously comprise:

a1) a step of extracting the fatty acids present in a neutralization paste coming from the refining, preferably the chemical refining, especially the saponification, of one or more oils chosen from a plant oil and an animal oil, this extraction step being performed in acidic medium under conditions that are efficient for forming an aqueous phase and an organic phase comprising said fatty acids,

a2) a separation step during which said organic phase formed previously is separated out and recovered.

The organic phase recovered in step a2) constitutes an acid oil. Such an acid oil generally has a water content of less than or equal to 3% by weight.

Neutralization Paste Used in Step a1)

The neutralization paste treated in step a1) may be a mixture of neutralization pastes coming from the refining of different oils or may be a neutralization paste coming from the refining of a single oil. Preferably, the refining of the neutralization paste(s) is chemical refining.

Such neutralization pastes originate, especially directly, from the saponification of a plant oil and/or an animal oil. In general, this saponification is performed by adding a base, generally sodium hydroxide, and makes it possible to remove the free fatty acids present in the oil, which are in the neutralization paste (“soapstock”) in the form of fatty acid alkaline salts. Before this saponification, the plant and/or animal oil may undergo a degumming or demucilagination operation directed towards removing the phospholipids, lecithins, sugar complexes and other impurities. The separation of the oil and of the neutralization paste resulting from the saponification may be performed by centrifugation.

The neutralization pastes thus essentially comprise fatty acids neutralized with a base. They typically comprise from 20% to 70% by weight of fatty acids.

In addition to the fatty acids neutralized with a base, the neutralization pastes may contain, depending on their origin and the quality of the saponification, phospholipids or unreacted mono-, di- or triglycerides. Usually, the fatty acids have C₁₂-C₂₄, preferably C₁₆-C₂₀ or better still C₁₆-C₁₈ carbon-based chains.

A neutralization paste is thus a product coming from biomass. Advantages associated with such neutralization pastes lie, firstly, in their low processing cost and, secondly, in the absence of undesirable toxic substances, such as pesticides, aflatoxins, heavy metals, dioxin and furan precursors, PCBs and nitrites.

Extraction Step a1)

The function of the extraction step a1) of the process according to the invention is to extract the fatty acids contained in the neutralization paste. This extraction is performed in acidic medium under conditions that are effective for forming an aqueous phase and an organic phase comprising the fatty acids initially contained in the neutralization paste.

This organic phase comprising the fatty acids is generally referred to as the “acid oil” or the “neutralization oil”.

The acid used for extracting the fatty acids present in the neutralization paste in salt form is generally an inorganic acid, for instance sulfuric acid, phosphoric acid or hydrochloric acid.

However, sulfuric acid is preferred since it allows better extraction of the fatty acids at a favourable economic cost.

The extraction is generally performed with heating, at a temperature generally between 70 and 100° C. (limits inclusive), preferably between 80 and 90° C. (limits inclusive).

In order to obtain good extraction of the fatty acids, an acidic pH is preferably maintained during the reaction, for example a pH of less than or equal to 6, preferably less than or equal to 4.

The reaction time is chosen to allow extraction of all of the fatty acids. It is, for example, from 1 hour to 24 hours, depending on the geometry of the reactor, and the nature and composition of the charge to be treated.

The extraction is preferably performed with stirring.

An aqueous phase and an organic phase containing the fatty acids are thus formed.

Separation Step a2)

During this step, the organic phase formed in step a1) is separated from the aqueous phase. In other words, the acid oil is isolated.

This separation may be performed by distillation, decantation or even centrifugation. This step may be performed via any suitable, known and commercially available device.

Advantageously, this separation is performed by decantation, followed by removal of the aqueous phase. The decantation depends on the difference in density of the liquids and on their viscosity, these parameters being able to be modified in a known manner by a person skilled in the art to promote the separation, where appropriate.

Esterification Step b)

The esterification step b) is performed under conditions that are effective for converting into esters at least some of the fatty acids present in the acid oil.

Advantageously, at least 50% by weight of the fatty acids are esterified, preferably at least 70% by weight, more preferentially at least 90% by weight. In particular, all of the fatty acids may be converted into esters, it being understood that non-esterified fatty acids may nevertheless remain in trace amount.

The esterification reaction is well known to those skilled in the art and consists of condensation of a carboxylic acid group —COOH and an alcohol group —OH. A person skilled in the art can adapt the reaction conditions so as to obtain more or less complete esterification of an acid oil.

The esterification may be performed in the presence of one or more alcohols.

The alcohol is preferably chosen from polyhydric alcohols.

According to a preferred embodiment, the alcohol is preferably chosen from cyclic or acyclic polyhydric alcohols comprising at least three hydroxyl groups.

“Cyclic” refers to a polyhydric alcohol comprising at least one ring. This ring is advantageously a ring containing 5 or 6 atoms, optionally including an oxygen atom.

Examples of polyhydric alcohols containing at least three hydroxyl groups are those containing from 3 to 10, preferably from 3 to 6 and more preferentially from 3 to 4 hydroxyl groups.

Advantageously, the polyhydric alcohols used in the present invention comprise from 2 to 90, preferably from 2 to 30 and more preferentially from 2 to 12 carbon atoms.

As examples of acyclic polyhydric alcohols, mention may be made of glycerol, diglycerol and sorbitol.

As an example of a cyclic polyhydric alcohol, mention may be made of sorbitan.

Preferably, step b) is performed in the presence of an acyclic polyhydric alcohol, such as glycerol.

According to a preferred embodiment, especially when the polyhydric alcohol comprises at least three hydroxyl groups, the esterification is performed so as to obtain at least 40% by weight, preferably from 40% to 55% by weight of monoesters, for example of monoglycerides when the esterification is performed with glycerol.

Advantageously, the proportions of monoesters is less than 80% by weight, preferably less than or equal to 70% by weight. In embodiments, the proportion of monoesters may be of 40 to 70% by weight, from 40 to 80% by weight or from 40 to 55% by weight.

Advantageously, especially when the polyhydric alcohol comprises at least three hydroxyl groups, the esterification is performed according to any known process so as to obtain at most 10%, preferably at most 8% and more preferentially at most 5% by weight of triesters, for example of triglycerides when the esterification is performed with glycerol. Each of these proportions of triesters can be obtained for a proportion of monoesters of at least 40% by weight, especially less than 70% by weight or 80% by weight, or for a proportion of monoesters of 40 to 70% by weight, from 40 to 80% by weight or from 40 to 55% by weight.

The proportions of monoesters and/or triesters mentioned above thus correspond to the proportions of these compounds in the lubricant additive obtained by the process according to the invention.

According to a particular embodiment, the lubricant additive has an iodine number measured according to standard ASTM D5768 of between 10 and 250 g I₂/100 g (limits inclusive), preferably between 50 and 200 g I₂/100 g (limits inclusive) and more preferentially between 80 and 125 g I₂/100 g (limits inclusive). In embodiments, the lubricant additive may have an iodine number in one of these ranges of values for each of the proportions of monoesters or triesters mentioned above taken alone or in combination.

According to a particular embodiment, the lubricant additive has a pour point measured according to standard ASTM D97 of less than or equal to 0° C., preferably less than or equal to −6° C. and more preferentially less than or equal to −12° C. In embodiments, the lubricant additive may have a pour point in one of these ranges of values for each of the proportions of monoesters or triesters mentioned above taken alone or in combination. The lubricating additive may further comprise an iodine number in one of the ranges previously given, in particular for each of the proportions of monoesters or triesters mentioned above taken alone or in combination.

Preferably, the esterification step b) is performed in the presence of glycerol.

Advantageously, before its esterification, the acid oil provided in step a) may undergo one or more treatment steps chosen from centrifugation, filtration and precipitation. This or these treatment steps may advantageously be performed on an acid oil obtained in step a2) described previously.

Advantageously, a step of treatment, especially by centrifugation, may be performed under conditions that are effective for obtaining an acid oil with a water content of less than or equal to 1% by weight, or even less than or equal to 0.8% by weight and in particular from 0.1% to 0.7% by weight.

Besides the removal of water, recovered in an aqueous phase, centrifugation may also allow the removal of some of the solid residues in suspension.

The centrifugation step has the advantage of being easy to perform, avoiding recourse to complex chemical separation methods, such as distillation, which may be restrictive in terms of undesirable corrosion and precautions, and expensive.

The centrifugation step may advantageously be a three-phase centrifugation.

However, the centrifugation step may itself be a combination of steps, and may in particular comprise a first step of centrifugation of two-phase type, which makes it possible to separate the materials in suspension in the form of sludges, coupled with a second step of three-phase centrifugation, which separates the organic phase, the purified aqueous phase and the residual materials in suspension from the first centrifugation. This step may be performed via any suitable, known and commercially available device.

Conventionally, the centrifugation may be performed with speeds of 4000-6000 rpm.

The centrifugation time depends on the nature of the species to be separated, their partition coefficient, the difference in density between the aqueous phase, the oily organic phase and the particles, the size of the particles, the surface tension of the species to be separated, the temperature and the centrifugation speed. The separation time (also known as the residence time) is thus adapted on a case-by-case basis by a person skilled in the art via conventional measurement and control means.

The filtration may be performed using a filter press, or a filter cartridge, or a filter membrane, or may be ultrafiltration, nanofiltration or filtration by reverse osmosis.

The filtration may especially be performed by means of at least one passage through a cellulose filter. Such a cellulose filter may make it possible to improve the filtration efficacy by avoiding clogging.

The treatment may comprise a succession of filtrations using filters of decreasing mesh sizes to achieve the final target, for example starting from 200 μm down to 25 μm. Advantageously, the final filtration step is then performed using a filter which has a filtration threshold of from 10 to 25 μm. By way of example, the filtrations may be performed using a first filter of 100 to 50 μm and a second filter of 10 to 25 μm.

The precipitation step may advantageously be performed under conditions that are effective for precipitating the sulfates that may be present in the acid oil. These sulfates may originate from the saponification of the oil and/or from the extraction with acid of the fatty acids.

Without wishing to be bound by a theory, the precipitation of the sulfates appears to be associated with the precipitation of calcium, phosphorus, sodium, and optionally alkali metals other than sodium, which has the effect of decreasing the ash content of the product.

In general, the conditions for performing the precipitation will be determined by a person skilled in the art via conventional means as a function of the species to be precipitated.

Precipitation of the sulfates may especially be performed by adding Ca²⁺ ions, for example in the form of CaCl₂ (calcium chloride).

One or more treatment steps chosen from centrifugation, filtration and precipitation may thus make it possible to reduce the water, ash, sulfur, calcium, phosphorus and sodium content of the acid oil. The choice and number of these substeps may be readily determined by a person skilled in the art by checking the contents of these elements.

The manufacturing process described previously makes it possible to obtain a lubricant additive which may advantageously be added to an internal combustion engine fuel composition so as to improve its lubricity. In other words, the esterified acid oils obtained via the process according to the invention may be used as lubricant additive for internal combustion engine fuel.

The invention thus makes it possible to prepare an internal combustion engine fuel composition, especially a diesel, having a sulfur content of less than 500 ppm by weight and comprising a lubricant additive according to the invention.

The content of lubricant additive in the fuel composition is preferably sufficient for the fuel composition to have a lubricant power of less than or equal to 500 μm, preferably less than or equal to 460 μm, preferentially less than or equal to 400 μm and more preferentially less than or equal to 300 μm under the conditions of the HFRR (High Frequency Reciprocating Rig) test as described in the article SAE 932692 by J. W. Hadley from the University of Liverpool.

The content of lubricant additive in the fuel composition is also preferably less than or equal to 1000 ppm (by weight), preferably less than or equal to 500 ppm by weight, preferentially between 10 and 400 ppm by weight (limits inclusive), more preferentially between 10 and 250 ppm by weight (limits inclusive).

The fuel composition may comprise at least one fuel chosen from diesels, diesel fuels containing biodiesel, petrols, biofuels, jet fuels, preferably diesels and diesel fuels containing biodiesel.

The fuel composition may especially comprise at least one fuel chosen from middle distillates with a boiling point of between 100 and 500° C., preferably 140 to 400° C.

These middle distillates may be chosen, for example, from the distillates obtained by direct distillation of crude hydrocarbons, vacuum distillates, hydrotreated distillates, distillates coming from catalytic cracking and/or hydrocracking of vacuum distillates, distillates resulting from conversion processes such as ARDS (atmospheric residue desulfurization) and/or viscoreduction, distillates coming from the upgrading of Fischer-Tropsch fractions, distillates resulting from BTL (biomass-to-liquid) conversion of plant and/or animal biomass, and/or mixtures thereof.

The fuels may also contain distillates coming from refining operations that are more complex than those coming from the direct distillation of hydrocarbons. The distillates may, for example, originate from cracking, hydrocracking and/or catalytic cracking processes and viscoreduction processes.

The fuels may also contain novel sources of distillates, among which mention may be made especially of:
the heaviest fractions coming from cracking and viscoreduction processes that are concentrated in heavy paraffins, comprising more than 18 carbon atoms,
synthetic distillates coming from the conversion of gas such as those coming from the Fischer-Tropsch process,
synthetic distillates resulting from the treatment of biomass of plant and/or animal origin, especially such as NexBTL,
and plant and/or animal oils and/or esters thereof, preferably fatty acid methyl esters (FAME) or fatty acid ethyl esters (FAEE), in particular plant oil methyl esters (POME) or plant oil ethyl esters (POEE),
hydrotreated and/or hydrocracked and/or hydrodeoxygenated (HDO) plant and/or animal oils.

The fuel composition may contain solely novel sources of distillates or may be composed of a mixture with standard petroleum middle distillates as diesel-type fuel base. These novel sources of distillates generally comprise long paraffinic chains of greater than or equal to 10 carbon atoms and preferentially from C₁₄ to C₃₀.

In general, the sulfur content of the fuel composition according to the invention is less than 500 ppm, preferably less than 50 ppm, or even less than 10 ppm by weight and advantageously is free of sulfur, especially for diesel-type fuels.

The lubricant additive obtained via the manufacturing process according to the invention described above may be used alone or as a mixture with one or more additives to improve the lubricity of a fuel composition.

The lubricant additive obtained via the process according to the invention may be used in the fuel composition in combination with one or more additional additives. These additional additives may be chosen from dispersants/detergents, carrier oils, metal deactivators, metal passivators, antioxidants, colourants, antistatic additives, corrosion inhibitors, biocides, markers, heat stabilizers, emulsifiers, antistatic additives, friction reducers, surfactants, ketane enhancers, antifogging agents, additives for improving the conductivity, reodorants, and mixtures thereof.

Among the other additional additives, mention may be made particularly of:

a) proketane additives, for instance alkyl nitrates;

b) antifoam additives: examples of such additives are given in EP 0 861 182, EP 0 663 000 and EP 0 736 590;

c) detergent and/or anticorrosion additives: examples of such additives are given in EP 0 938 535, US 2012/0 010 112 and WO 2012/004 300;

e) cloud point additives. Examples of such additives are given in EP 0 071 513, EP 0 100 248, FR 2 528 051, FR 2 528 051, FR 2 528 423, EP 112 195, EP 0 172 758, EP 0 271 385 and EP 0 291 367;

f) anti-sedimentation and/or paraffin-dispersing additives. Examples of such additives are given in EP 0 261 959, EP 0 593 331, EP 0 674 689, EP 0 327 423, EP 0 512 889, EP 0 832 172, US 2005/0 223 631, U.S. Pat. No. 5,998,530 and WO 1993/014 178;

g) cold-flow polyfunctional additives chosen especially from the group formed by polymers based on olefin and alkenyl nitrate as described in EP 0 573 490;

h) additives for improving the cold resistance and filterability (CFI), such as ethylene/vinyl acetate (EVA) and/or ethylene/vinyl propionate (EVP) copolymers;

i) other antioxidants of hindered phenolic and amine type such as alkyl para-phenylenediamines;

j) metal passivators, such as triazoles, alkyl benzotriazoles and alkyl tolutriazoles;

k) metal sequestrants such as disalicylidene propane diamine (DMD);

l) acidity neutralizers such as cyclic alkylamines.

A fuel composition may thus be obtained via a process comprising:
(1) a step of providing one or more fuels,
(2) a step of adding to the fuel(s) provided in step (1) at least one lubricant additive obtained via the process according to the invention.

The process may optionally comprise a step of adding at least one additional additive of the type described above.

The lubricity of an internal combustion engine fuel composition may thus be improved via a process comprising a step during which at least one lubricant additive obtained via the manufacturing process according to the invention is added to a fuel composition.

To explain the advantages of the present invention, examples are given below as non-limiting illustrations of the scope of the claimed invention.

The following abbreviations were used:

AO: acid oil,
FFA: free fatty acids,
MG: monoglycerides,
DG: diglycerides,
TG: triglycerides,
POME: plant oil methyl esters,
Cx:y, fatty acid containing x carbon atoms and y unsaturations (carbon-carbon double bonds).

### EXAMPLES

In the present application, the meaning of the term “weight” is the usual meaning of “mass” in everyday language.

The lubricant power of several additives in two fuels of diesel type for diesel engines was tested under the conditions of the HFRR (high frequency reciprocating rig) test as described in the article SAE 932692 by J. W. Hadley from the University of Liverpool. This lubricant power may thus be defined as the property of a liquid determined by measuring the wear mark produced by the contact of an oscillating ball on a fixed plate immersed in the liquid and under strictly controlled conditions.

The test consists in jointly imposing on a steel ball in contact with an immobile metal plate a pressure corresponding to a weight of 200 g and an alternating movement of 1 mm at a frequency of 50 Hz. The ball in motion is lubricated by the composition to test. The temperature is maintained at 60° C. throughout the test, i.e. for 75 minutes. The lubricant power is expressed by the mean value of the diameters of the wear imprint of the ball on the plate. The smaller the wear diameter, the better the lubricant power. Generally, a wear diameter of less than or equal to 460 μm±63 μm is required for a diesel-type fuel.

The characteristics of the diesels tested are given in Table 1.

TABLE 1
Characteristics of the diesels

| | | Diesel | Diesel | | |
|---|---|---|---|---|---|
| | | No 1 | No 2 | Standard | Unit |
| Limit filterability | | −7 | −19 | NF EN 116 | ° C. |
| temperature | | | | | |
| Pour point | | −12 | N.A. | ASTM D97 | ° C. |
| Cloud point | | −5 | −16 | ASTM D7689 | ° C. |
| Mass per unit | | 830.2 | 826.0 | NF EN ISO12185 | kg/m³ |
| volume at 15 C. | | | | | |
| Sulfur content | | <10 | <3 | EN ISO20846 | Mg/kg |
| | | (7.8) | | EN ISO20884 | |
| POME content | | 0.024 | 0.024 | EN14078 | % vol |
| Distillation | | | | | |
| IPB | 0 | 169 | 235 | ASTM D86 | ° C. |
| T5 | 5% | 190 | 250 | | |
| T10 | 10% | 199 | 255 | | |
| T20 | 20% | 214 | 262 | | |
| T30 | 30% | 229.0 | 269 | | |
| T40 | 40% | 246 | 276 | | |
| T50 | 50% | 262 | 282 | | |
| T60 | 60% | 280.0 | 289 | | |
| T70 | 70% | 298.0 | 296 | | |
| T80 | 80% | 316 | 304 | | |
| T90 | 90% | 339 | 308 | | |
| T95 | 95% | 356 | 324 | | |
| FBP | 100% | 364 | 332 | | |

Various additives were added to these diesels in amounts ranging from 100 to 300 ppm (by weight) according to the tests. An HFRR test was performed for each additive so as to determine the lubricant power.

The acid oil is directly coming from a process of acidification of at least one neutralization paste obtained via a process of refining (in this case saponification) of one or more plant and/or animal oils.

### Production of the Acid Oil and of the Esterified Acid Oil

A neutralization paste underwent the following treatment:
injection of 120 l of 97% sulfuric acid into a reactor containing 4000 kg of neutralization paste, in which the temperature is from 80 to 90° C. The reaction time is 24 hours, with continuous monitoring of the pH so as to maintain the pH at a value below 4,
decantation of the aqueous phase and of the organic phase formed during step a1), followed by removal of the aqueous phase.

An acid oil noted AO is obtained.

This acid oil AO undergoes esterification with glycerol so as to obtain at least 40% by weight of monoglycerides and less than 10% by weight of triglycerides. An esterified acid oil known as AO ester and containing 49.2% by weight of monoglycerides, less than 10% by weight of triglycerides and an iodine number measured according to standard ASTM D5768 of 115 g I₂/100 g is obtained.

Table 2 collates the characteristics of two commonly used lubricant additives. The comparative additive No. 1 is a mixture of fatty acid esters essentially containing mono- and diglycerides. The comparative additive No. 2 is a mixture essentially containing free fatty acids.

The comparative additive No. 3 is a TOFA ester obtained by esterification of the comparative additive No. 2. The esterification is performed under conditions similar to those used for the AO ester, namely with glycerol so as to obtain at least 40% by weight of monoglycerides and less than 10% by weight of triglycerides.

TABLE 2
Characteristics of the comparative additives tested

| | Comparative | Comparative |
|---|---|---|
| Additive | No. 1 | No. 2 (TOFA) |
| FFA (wt %) | 0 | 96.9 |
| MG (wt %) | 45.1 | 0 |
| DG (wt %) | 42.5 | 0 |
| TG (wt %) | 10 | 0 |
| Pour point (° C.) | −21 | −15 |
| Content of FFA | 78.2 | 86.1 |
| C18:1 + C18:2 (wt %) | | |
| Content of FFA with a | 8.2 | 0.3 |
| number of | | |
| unsaturations >2 (wt %) | | |

### Example 1

In this example, various additives were added to diesel No. 1.

The results are collated in Table 3.

The values indicated correspond to the mean of the results obtained, which are within an interval of ±10 μm.

It is found that the lubricant power of the esterified acid oil is visible at and above 200 ppm (result of the HFRR test less than or equal to 300 μm), whereas contents of 300 ppm are necessary for the comparative lubricant additives.

TABLE 3
Lubricant power of diesel No. 1 in
the presence of various additives

| Additive | Dosage (mg/kg) | HFRR (μm) |
|---|---|---|
| AO ester | 0 | 598 |
| | 100 | 504 |
| | 200 | 280 |
| | 300 | 270 |
| AO | 0 | 598 |
| | 100 | 485 |
| | 200 | 444 |
| | 300 | 420 |
| Comparative No. 1 | 0 | 598 |
| mono- and diglyceride | 100 | 457 |
| | 200 | 364 |
| | 300 | 270 |
| Comparative No. 2 | 0 | 598 |
| TOFA | 100 | 432 |
| | 200 | 427 |
| | 300 | 412 |
| Comparative No. 3 | 0 | 598 |
| TOFA ester | 100 | 338 |
| | 200 | 332 |
| | 300 | 297 |

### Example 2

In this example, various additives were added to diesel No. 2.

The results are collated in Table 4.

The values indicated correspond to the mean of the results obtained, which are within an interval of ±10 μm.

TABLE 4
Lubricant power of diesel No. 2 in
the presence of various additives

| Additive | Dosage (mg/kg) | HFRR (μm) |
|---|---|---|
| AO ester | 0 | 575 |
| | 100 | 451 |
| | 200 | 224 |
| Comparative No. 1 | 0 | 575 |
| mono- and diglyceride | 100 | 376 |
| | 200 | 256 |
| Comparative No. 2 | 0 | 575 |
| TOFA | 100 | 456 |
| | 200 | 410 |

1. Process for manufacturing a lubricant additive for internal combustion engine fuel, comprising:
a) a step of providing an acid oil containing fatty acids, said acid oil being coming from the acidification of a neutralization paste obtained via a process for refining, especially a process for saponifying, one or more oils chosen from a plant oil and an animal oil,
b) a step of esterifying the acid oil obtained in step a), performed under conditions that are effective for converting into esters at least part, preferably all, of the fatty acids present in the acid oil.

2. Manufacturing process according to claim 1, in which, during the esterification step b), at least 50% by weight of the fatty acids are esterified, preferably at least 70% by weight, more preferentially at least 90% by weight.

3. Manufacturing process according to claim 1, in which the esterification step b) is performed in the presence of cyclic or acyclic polyhydric alcohol.

4. Manufacturing process according to claim 3, in which the esterification step b) is performed in the presence of a polyhydric alcohol containing at least three hydroxyl groups.

5. Manufacturing process according to claim 3 in which the esterification step b) is performed in the presence of an acyclic polyhydric alcohol, preferably glycerol.

6. Manufacturing process according to claim 1, in which the esterification step b) is performed under conditions that are effective for obtaining at least 40% by weight and preferably from 40% to 55% by weight of monoesters.

7. Manufacturing process according to claim 1, in which the esterification step b) is performed under conditions that are effective for obtaining at most 10% by weight, preferably at most 8% by weight and more preferentially at most 5% by weight of triesters.

8. Manufacturing process according to claim 1, in which the acid oil provided in step a) is coming from the acidification of a neutralization paste obtained via a process of refining one or more plant oils.

9. Manufacturing process according to claim 1, in which step a) of providing an acid oil comprises:
a1) a step of extracting the fatty acids present in a neutralization paste coming from the refining of one or more oils chosen from a plant oil and an animal oil, this extraction step being performed in acidic medium under conditions that are efficient for forming an aqueous phase and an organic phase comprising said fatty acids,
a2) a separation step during which said organic phase formed previously is separated out and recovered,
the organic phase recovered in step a2) constituting an acid oil.

10. Manufacturing process according to claim 1, in which, before the esterification step b), the acid oil provided in step a) undergoes one or more treatment steps chosen from centrifugation, filtration and precipitation.

11. Manufacturing process according to claim 10, in which, during a treatment step, the acid oil obtained in step a) is treated under conditions that are effective for obtaining an acid oil with a water content of less than or equal to 1% by weight, or even less than or equal to 0.8% by weight, in particular from 0.1% to 0.7% by weight.

12. Process for obtaining a fuel composition, comprising:
(1) a step of providing one or more fuels,
(2) a step of adding to the fuel(s) provided in step (1) at least one lubricant additive obtained via the manufacturing process according to claim 1, alone or as a mixture with one or more additional additives.

13. An esterified acid oil(s) for use as a fuel lubricity additive for an internal combustion engine, wherein the esterified acid oil is obtained by the manufacturing process according to claim 1.
